(19) United States
(12) Patent Application Publication
(10) Pub. No.: US 2009/0081438 A1
(43) Pub. Date: Mar. 26, 2009

(54) Stab Resistant Insert for Protective Textile Product

(76) Inventor: Pol Speleers, Waregem (BE)

Correspondence Address: BACON & THOMAS, PLLC, 625 SLATERS LANE, FOURTH FLOOR, ALEXANDRIA, VA, 22314-1176, US

(21) Appl. No.: 12/086,183

(22) PCT Filed: Dec. 1, 2006
(86) PCT No.: PCT/EP2006/011566

§ 371 Date: Jun. 6, 2008

(30) Foreign Application Priority Data
Dec. 8, 2005 (EP) 05447276.6

(51) Int. Cl. D03D 15/02; B32B 15/02; F41H 5/04; F41H 1/02

(52) U.S. Cl. 428/220; 442/229

(57) ABSTRACT

A stab resistant insert for protective textile product (400, 500), being a textile fabric (10, 20, 30,401, 402, 403, 501) comprises at least a first layer (110) of fibers and a second layer (120) of fibers. The fibers of this first layer (110) and second layer (120), are metal multifilament yarns (111, 121). The textile fabric (10, 20, 30, 401, 402, 403, 501) is a multi-layered woven fabric. The metal multifilament yarns (111, 121) are bundle drawn metal multifilament yarns.

### TECHNICAL FIELD OF THE INVENTION

The present invention relates to protective textile products and more particular to stab resistant protective garments or stab resistant canvasses as well as methods of making the same.

### BACKGROUND OF THE INVENTION

Protective textile products at present may be designed to provide different types of protection simultaneously, such as ballistic protection, stab resistance and/or cut resistance. As the requirements for the different types of protection are not identical, the protective textile product usually comprises a number of different inserts. Each insert is to fulfill a part or all of the requirements necessary to provide one particular type of protection.

The stab resistance of a protective textile product requires that the composing elements have a lateral resistance against cutting. The terms “lateral resistance” refer to resistance in a direction perpendicular to the longitudinal axes of the various elongated elements which make up the textile products. It is hereby understood that aramide yarns, while providing an excellent ballistic protection, do not provide an acceptable stab resistance. The perforation of a textile product by a steel bladed weapon brings into play several phenomena: first of all the blade penetrates between the interstices of the textile, displaces the yarns or fibres and then next cuts them with the cutting side of the blade. A good stab resistant multi layer product has to show at least some of the following properties:

a good cut resistance of the individual fibers , yarns and layers;

a low module of elasticity;

a low inter yarn or inter layer coefficient of friction in order to encourage the dissipation of energy.

Ballistic protection of textile layers on the other hand requires at least some of the following properties:

a high tensile strength and modulus;

a low elongation.

A protective textile product having stab resistance properties is described in WO 92/08095A1. The protective textile product, being a garment and more particular a bulletproof vest, comprises an insert comprising several layers of fibers, which layers are coupled to each other by means of a binding yarn. Although these bound layers already provide some stab resistance, WO92/08095A1 describes additional planar bodies to be fixed to the outer surface of the garment, in order to provide high penetration resistance.

### SUMMARY OF THE INVENTION

It is an object of the present invention to provide an improved stab resistant insert for a protective textile product and a method of making the textile product. It is also an object of the present invention to provide a protective textile product, such as a garment or canvass comprising an insert having stab resistance properties and a method of making the textile product.

At least some of the above objectives are accomplished by a stab resistant insert for a protective textile product according to the present invention, having the features as set out in present claim 1.

It is an advantage of the stab resistant insert for protective textile product according to at least some of the embodiments of the present invention that it has good stab resistance, e.g. improved stab resistance compared to prior art stab resistant inserts. Also the corresponding protective textile product comprising the stab resistant insert according to at least some of the embodiments of the present invention has good stab resistance, e.g. improved stab resistance compared to prior art protective textile products.

It is further an advantage of the stab resistant insert according to at least some of the embodiments of the present invention, that it has good dimensional stability, e.g. improved dimensional stability with respect to prior art stab resistant inserts. Also the corresponding protective textile product comprising the stab resistant insert according to at least some of the embodiments of the present invention has good dimensional stability, e.g. improved dimensional stability compared to the prior art devices.

It is also advantage of the stab resistant insert according to at least some of the embodiments of the present invention, that it has a good flexibility, e.g. higher flexibility than prior art stab resistant inserts. This increases the comfort of wear and/or use of a protective textile product comprising such stab resistant insert as a whole.

It is another advantage of the stab resistant insert according to at least some of the embodiments of the present invention, that it has a high penetration resistance measured according to the NIJ standard 0115.00. A protective textile product according to at least some of the embodiments of the present invention comprising such a stab resistant insert, by its high penetration resistance can avoid planar bodies to be fixed to the outer surface of the protective textile product.

It is further an advantage of the stab resistant insert of at least some of the embodiments of the present invention that it can easily be combined with additional inserts, thus providing other types of protections such as e.g., but not limited thereto, bullet resistance or cut resistance, meanwhile avoiding the thickness of the protective textile product comprising such stab resistant insert to increase too dramatically.

It is still another advantage of a stab resistant insert according to at least some of the embodiments of the present invention that its insert properties are not influenced by circumstances of use, such as e.g., but not limited thereto, temperature of the environment, degradation by UV-light, weather circumstances during use, transpiration of persons wearing a protective textile product comprising such stab resistant insert, and many more.

It is an additional advantage of a stab resistant insert according to at least some of the embodiments of the present invention that it does not show a lowered risk in usage after being subjected to a former impact. Therefore also a protective textile product comprising such stab resistant insert does not show a lowered risk in usage after being subjected to a former impact.

It is an additional advantage of a stab resistant insert according to at least some of the embodiments of the present invention that it does not cause risk of injuries to the user after being subjected to an insert. Also a protective textile product comprising such stab resistant insert according to at least some of the embodiments of the present invention does not cause risk of injuries to the wearer after being subjected to an insert, e.g. injuries by puncture of loose ends of ruptured wires or other components of the fabric being part of the textile product. This is an advantage the product has over steel cord woven or knitted products: after impact of a knife or even a bullet, no filaments will stick out of the fabric according to embodiments of the present invention. In case of steel cord woven/knitted products, after impact of a knife or bullet, wire-like filaments may be caused to point outwards or inwards the product, possibly causing scratching or stinging in the body of the wearer.

In a first aspect, the present invention provides a stab resistant insert for protective textile product. Said insert is a textile fabric, the fabric comprising at least a first and a second layer of fibers. In the stab resistant insert according to embodiments of the present invention, the fibers of each of these first and second layer, are metal multifilament yarns, being bundle drawn metal multifilament yarns. The textile fabric as subject of the present invention is provided as a multi-layered woven fabric.

The term multi-layered woven fabric is to be understood as the woven fabric comprising at least two layers of weft insertions, one layer being located above the other in a cross-section of the woven fabric in a plane perpendicular to the fabric surface.

According to embodiments of the present invention, the multifilament yarns of the first and second layer provide a first and a second layer of weft insertions of the multi-layered woven fabric. According to embodiments of the present invention, the textile fabric may have a number of weft insertions per layer of weft insertions in the range of 80 to 150 per dm, counted in warp direction.

According to embodiments of the present invention, the textile fabric may comprise a binding yarn being provided as warp yarn for forming the multi-layered woven fabric by interlacing with said at least one of said first and second layer. Preferably the binding yarn interlaces with said first and second layer. The term “interlacing” is to be understood as a warp yarn crossing at least one weft insertion twice in a direction parallel to surface of the woven fabric, so the weft insertion is substantially prevented to displace in the woven fabric.

According to embodiments of the present invention, the textile fabric has a fabric density of more than 1700 g/dm³.

According to at least some embodiments of the present invention, the stab resistant insert for protective textile as subject of the present invention may have a thickness being in the range of 0.9 and 2 mm.

According to at least some of the embodiments of the present invention the binding yarns may be provided as multifilament yarns, such as preferably bundle drawn metal multifilament yarn or as polymer multifilament yarn.

According to at least some of the embodiments of the present invention, the metal for providing the metal multifilament yarns, such as bundle drawn metal multifilament yarns is preferably stainless steel such as from the AISI 300 or AISI 400-series. The filaments of the metal multifilament yarns preferably have an equivalent diameter in the range of 1 to 60 μm.

The term “equivalent diameter” is to be understood as the diameter of an imaginary circle, which surface is identical to the average surface of radial cross-section of the filament. Bundle drawn metal multifilaments can have a polygon-like radial cross-section, such as penta- or hexagonal in case the bundle drawn metal multifilaments are provided by the method as disclosed in U.S. Pat. No. 3,379,000 or rectangular or triangular

The average surface is calculated using a statistically representative number of cross-sections, which number may be obtained from presently well-known and accepted sampling standards such as Mill Standard 414.

According to at least some of the embodiments of the present invention, the metal multifilament yarn, such as bundle drawn metal multifilament yarn, may be provided as singles yarns or as multiple plied yarns comprising at least two singles yarns. The singles or multiple plied yarns, comprising at least 2 singles yarns, may comprise a number of filaments per yarn cross-section, varying preferably in the range of 80 to 2200 per yarn cross-section, such as ranging from 90 to 2200. The singles yarns, e.g. when being a part of a multiple plied yarn may comprise a number of filaments per cross section ranging preferably between 90 to 1000. The metal multifilament yarn, such as bundle drawn metal filament yarn, may have a yarn fineness in the range of 100 to 2200 Tex, preferably in the range of 250 to 1000 Tex.

The construction of the multi-layered woven fabric used to provide the stab resistant insert for protective textile is an independent aspect of at least some embodiments of the present invention. The at least two layers of weft insertion are best seen in a section in a plane being parallel to the warp direction. Most preferred, the weft insertions of two different layers of weft insertions are located one above the other. They run from one selvedge of the fabric to the other selvedge at the same position in the warp direction. Alternatively, each weft insertion is present at a different position in warp direction.

According to at least some of the embodiments of the present invention, the binding yarns, being provided as warp yarns, preferably cross or pass through at least both the first and second layers of weft insertions, and preferably during one warp changeover. The term “warp changeover” is to be understood as a warp yarn changing from one position in direction perpendicular to the surface of the woven fabric, to another position in the direction perpendicular to the surface of the woven fabric, while crossing at least a weft insertion. Most preferred, the binding yarns interlace at least two weft insertions of the first layer of weft insertions or at least two weft insertions of the second layer of weft insertions between two consecutive changeovers.

According to at least some of the embodiments of the present invention, the woven fabric comprises at least a number of binding yarns per length unit of the fabric in weft direction, which number is in the range of 20 to 120 per dm such as in the range of 20 to 80 per dm. Most preferred, the binding yarns are mutually equally spaced.

According to at least some of the embodiments of the present invention, the woven fabric comprises at least a number of warp yarns providing a third layer of bundle drawn metal multifilament yarns. The multifilament yarns of this third layer provide an intermediate layer of warp yarns not interlacing with the multifilament yarns of the first and the second layer of weft insertions. The intermediate layer of warp yarns is interjacent and in contact with the first and the second layer of weft insertions. Preferably, the intermediate layer of warp yarns has a number of warp yarns per length unit in weft direction, which number is in the range of 60 to 220 per dm. Most preferred, the warp yarns of the intermediate layer of warp yarns are mutually equally spaced.

According to at least some of the embodiments of the present invention, the woven fabric may comprise at least one additional layer of weft insertions and/or at least one intermediate layer of warp yarns, which warp yarns are not interlacing with at least weft insertions of the first or second layers of weft insertions.

According to at least some of the embodiments of the present invention, the woven fabric has a number of weft insertions per layer of weft insertions in the range of 80 to 150 per dm, such as in the range of 80 to 120 per dm.

In a second aspect, the present invention relates to a protective textile product comprising a stab resistant insert according to embodiments of the present invention, wherein the protective textile product further comprises additional layers of fibers, e.g. polymer fibers, which additional layers of fibers may provide additional types of protection. As an example, the protective textile product comprises an insert in accordance with embodiments of the present invention and further may comprise one or more layers of fibers, such as polymer fibers, e.g. polyaromatic polyamide fibers, for making the protective textile product bullet proof on top of the stab resistance provided by the insert.

In a third aspect, the present invention further relates to a stab resistant insert being part of a protective textile product, which protective textile product is a garment, preferably a vest. Alternatively, the protective textile product may be a canvass or may be used as a protective curtain.

In a fourth aspect, the present invention relates to the use of a stab resistant insert according to embodiments of the present invention as an insert for a protective textile product such as a garment, e.g. a vest, or a canvass or a protective curtain.

In a further aspect, the present invention relates to the use of a protective textile product according to embodiments of the present invention, as a garment, e.g. a vest, or a canvass or a protective curtain.

Particular and preferred aspects of the invention are set out in the accompanying independent and dependent claims. Features from the dependent claims may be combined with features of the independent claims and with features of other dependent claims as appropriate and not merely as explicitly set out in the claims.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1a and FIG. 1b schematically illustrate a cross-section of an embodiment of a stab resistant insert for a protective textile product in warp and weft direction respectively, and perpendicular to the fabric surface.

FIG. 2 and FIG. 3 schematically illustrate a view of a cross-section in warp direction of two alternative embodiments of stab resistant inserts for a protective textile product.

FIG. 4 schematically illustrates a garment being a protective textile product comprising a stab resistant insert according to embodiments of the present invention.

FIG. 5 schematically illustrates a canvas being a protective textile product comprising a stab resistant insert according to embodiments of the present invention.

FIG. 6 schematically illustrates an enlarged cross-section of the canvass of FIG. 5.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

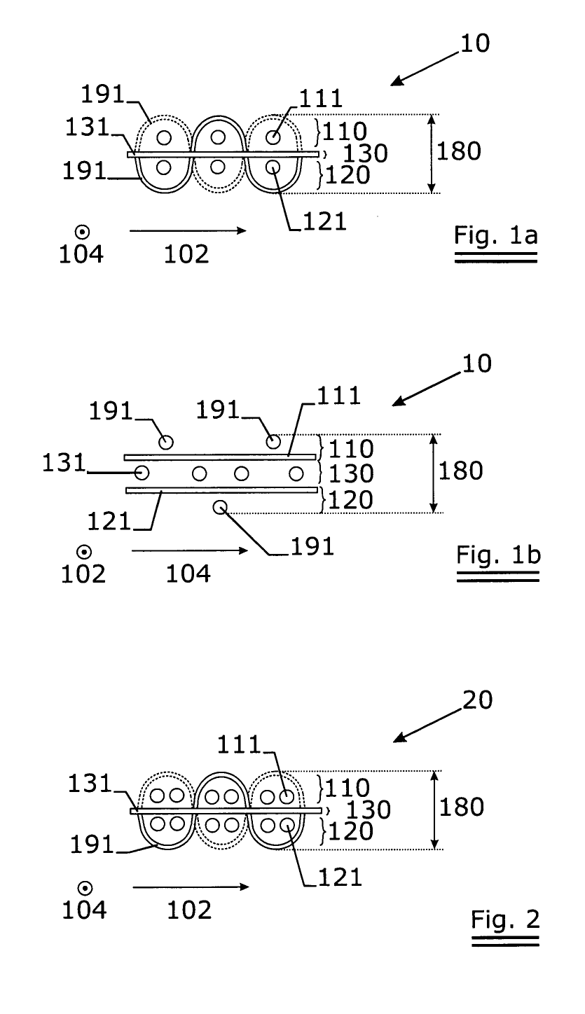

An embodiment of a stab resistant insert for a protective textile product is schematically shown in FIG. 1a and FIG. 1b. FIG. 1a is a view of a cross-section of the insert being textile fabric 10, which textile fabric 10 is a multi-layered woven fabric. The cross-section is in a direction perpendicular to the fabric surface and according to the warp direction (indicated with arrow 102). FIG. 1b is a view of a cross-section of the insert being textile fabric 10, which textile fabric 10 is a multi-layered woven fabric. The cross-section is in a direction perpendicular to the fabric surface and according to the weft direction (indicated with arrow 104).

The multi-layered woven fabric 10 comprises three layers 110, 120 and 130 of fibers, being bound together to form a woven fabric 110 by means of binding yarns 191. For each of the three layers 110, 120 and 130, the fibers are provided as bundle drawn metal filament yarns 111, 121 and 131 respectively. The bundle drawn metal filament yarns 111 present in layer 110 are provided as a first layer 110 of weft insertions in weft direction 104. The bundle drawn metal filament yarns 121 present in layer 120 are provided as a second layer 120 of weft insertions in weft direction 104. The multifilament yarns 131 of the third layer 130 are provided as an intermediate layer of warp yarns not interlacing with the multifilament yarns 121 and 131 of the first layer 110 and said second layer 120 of weft insertions. The intermediate layer 130 of warp yarns 131 are interjacent and in contact with the first layer 110 and the second layer 120 of weft insertions. The binding yarns 191 are provided in warp direction 104 and form a multi-layered woven fabric 10 by interlacing with the bundle drawn metal filament yarns 111 and 121 of the first layer 110 and second layer 120 of fibres. The multi-layered woven fabric according to this embodiment may have a fabric density in the range of 1700 and 3500 g/dm³, more in particular a fabric density of 2400 g/dm³. The values of features mentioned below are to be chosen so this fabric density is met.

The bundle drawn metal multifilament yarns 111, 121, 131 may be provided by presently known methods such as by providing a torsion to a composite wire, which composite wire comprises a number of bundle drawn metal filaments drawn to end equivalent diameter and encapsulated in a ductile matrix. After twisting such composite wire, the ductile matrix is removed, e.g. by dissolving the matrix in an acid environment, which however does not dissolve the metal of the bundle drawn metal filaments. A single ply bundle drawn metal filament yarn is provided this way. A bundle drawn metal filament multiple plied yarn may also be provided this way. Two or more single composite wires with or without having been given a torsion, are twined to provide an intermediate strand. Thereafter, the ductile matrix is removed, e.g. by dissolving the matrix in an acid environment, which however does not dissolve the metal of the bundle drawn metal filaments. A multiple plied yarn is provided this way, comprising a number of single yarns plied together, each singles yarn comprising a number of bundle drawn metal filaments.

The bundle drawn metal filament yarns 111 and 121 present in layers 110 and 120 are four plied bundle drawn metal filament yarns, provided out of any suitable material providing a lateral resistance against cutting when in filament form, e.g. provided out of AISI 316L-alloy. They are provided with an equivalent diameter of 12 μm. The multiple plied yarns 111 and 121 comprise 4 single yarns each comprising 275 filaments. The singles yarns are given a torsion rate of 100 turns per meter in Z direction, which are twined together in S direction with a twine rate of 100 turns per meter. The multiple plied yarns 111 and 121 have a fineness of 1000 Tex.

The bundle drawn metal filament yarns 131 present in layer 130 are 4 plied bundle drawn metal filament yarns, provided out of any suitable material, e.g. provided out of AISI 316L-alloy. They are provided with an equivalent diameter of 12 μm. The multiple plied yarns 131 comprise 4 single yarns each comprising 275 filaments. The singles yarns are given a torsion rate of 100 turns per meter in Z direction, which are twined together in S direction with a twine rate of 100 turns per meter. The multiple plied yarns 130 have a fineness of 1000 Tex.

The binding yarns 191 are also bundle drawn metal filament yarns. These bundle drawn metal filament yarns 191 are singles bundle drawn metal filament yarns, provided out of any suitable material, e.g. provided out of AISI 316L-alloy. They are provided with an equivalent diameter of 14 μm. The singles yarns 191 comprise 1 single yarn each comprising 90 filaments. The singles yarns are given a torsion rate of 100 turns per meter in Z direction. The multiple plied yarns 191 have a fineness of 110 Tex.

The yarns 111, 121, 131 and 191 are forming a multi-layered woven fabric 10, as the binding yarns 191 interlace with the weft insertions of the layers 110 and 120, being the bundle drawn metal filament yarns 111 and 121. The bundle drawn metal filament yarns 131 do not interlace with the weft insertions, this is the relative position of the yarns 131 and weft insertions 111 or 121 in a direction perpendicular to the fabric surface does not change for consecutive weft insertions.

During one warp changeover, this is when a warp yarn changes from one position in a direction perpendicular to the surface of the woven fabric 10, to another position in the direction perpendicular to the surface of the woven fabric 10, while crossing at least the layer 110 of weft insertions 111, the binding yarn 191 crosses at least the layer 120 of weft insertions 121. Between two consecutive warp changeovers, one weft insertion of either layer 110 or 120 is interlaced.

The consecutive binding yarns 191 in weft direction 104 are provided to weave according to a plain weaving structure. The bundle drawn metal filament yarns 131 do not interlace any weft insertion.

In each of the first and second layers 110, 120 of fibres, in warp direction, 150 weft insertions per dm in warp direction are provided. In layer 130, 120 bundle drawn metal filament yarns are provided per dm in weft direction 102. In weft direction, 120 binding yarns per dm are provided. The binding yarns 191 and the yarns 131 of layer 130 are alternating in such a way that each yarn 131 of layer 130 is adjacent to two binding yarns 191, and each binding yarn 191 is adjacent to two yarns 131 of layer 130.

The woven fabric 10 has a thickness 180, for example of 1.1 mm in a direction perpendicular to the fabric surface and a surface weight of 2150 gram per m². A fabric density of 2.4 kg/dm³ is provided.

In an alternative embodiment, the binding yarns of FIG. 1a and FIG. 1b are provided as a multifilament Para-aramid yarn, a high tenacity polyester multifilament yarn or a high density polyethylene multifilament yarn of 550 dtex. All other features are identical as for the woven fabric 10 of FIG. 1a and FIG. 1b as set out above. A woven fabric 10 has a thickness 180 of 1.1 mm in a direction perpendicular to the fabric surface and a surface weight of 2100 gram per m². A fabric density of 2.3 kg/dm³ is provided.

Another embodiment of a stab resistant insert for a protective textile product is schematically shown in FIG. 2, in which identical reference numbers as used for the embodiment of FIG. 1a and FIG. 1b refer to identical features. FIG. 2 shows a cross-section of an insert being textile fabric 20, the cross-section being in a direction perpendicular to the fabric surface and according to the warp direction. The textile fabric 20 is a multi-layered woven fabric.

During one warp changeover, this is when a warp yarn changes from one position in a direction perpendicular to the surface of the woven fabric, to another position in the direction perpendicular to the surface of the woven fabric, while crossing at least the layer 110 of weft insertions 111, the binding yarn 191 crosses at least the layer 120 of weft insertions 121. Between two consecutive warp changeovers, two weft insertions of layer 110 or two weft insertions of layer 120 are interlaced.

The consecutive binding yarns 191 in weft direction 104 are provided to weave according to a plain weaving structure. The bundle drawn metal filament yarns 131 does not interlace any weft insertion.

In each layer 110 and 120, in warp direction, 150 weft insertions per dm in warp direction are provided. In layer 130, 120 bundle drawn metal filament yarns are provided per dm in weft direction 102. In weft direction, 120 binding yarns per dm in weft direction are provided. The binding yarns 191 and the yarns 131 of layer 130 are alternating in such a way that each yarn 131 of layer 130 is adjacent to two binding yarns 191, and each binding yarn 191 is adjacent to two yarns 131 of layer 130.

The woven fabric of an insert 20 according to embodiments of the present invention has a thickness 180, for example, of 1.1 mm in a direction perpendicular to the fabric surface and a surface weight of 2800 gram per m². A fabric density of 3.1 kg/dm³ is provided.

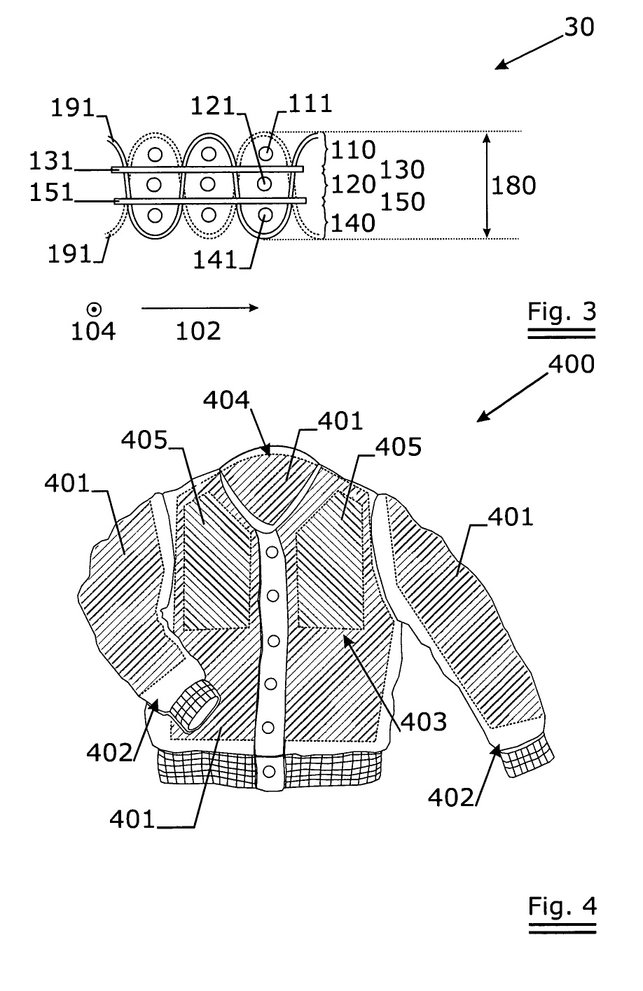

Another embodiment of a stab resistant insert for a protective textile product is schematically shown in FIG. 3, in which identical numbers as used for the embodiments of FIG. 1a, FIG. 1b and FIG. 2 refer to identical features. A cross-section of an insert according to embodiments of the present invention is shown, the insert being being textile fabric 30, the cross-section being in a direction perpendicular to the fabric surface and according to the warp direction. The textile fabric 30 illustrated is a multi-layered woven fabric.

The woven fabric 30 illustrated in FIG. 3 differs from the embodiment of FIG. 1a and FIG. 1b, in that an additional layer 140 of weft insertions and an additional intermediate layer 150 of warp yarns 151 are provided. The additional intermediate layer 140 is a layer of bundle drawn metal multifilament yarns 141. The warp yarns 151 are not interlacing with weft insertions of the layers 110, 120 and 140 of weft insertions. The layers 110, 120, 130, 140, and 150 are layers of bundle drawn metal filament yarns 111, 121, 131, 141 and 151, mutually not interlacing, and of which the outer layers are layers of weft insertions. The multifilament yarns 131 of the third layer 130 provide an intermediate layer 130 of warp yarns not interlacing with the multifilament yarns 111 and 121 of the first and second layers 110 and 120 of weft insertions, meanwhile this intermediate layer 130 of warp yarns is interjacent and in contact with the first and the second layer 110 and 120 of weft insertions. This is identical as in the embodiments shown in FIG. 1a, FIG. 1b and FIG. 2. The additional layers 140 and 150 provide so-to-say underlying additional layers, similar as how layers 130 and 120 provide additional layers to layer 110.

During one warp changeover, this is when a warp yarn changes from one position in a direction perpendicular to the surface of the woven fabric, to another position in the direction perpendicular to the surface of the woven fabric, while crossing at least the layer 110 of weft insertions 111, the binding yarn 191 crosses at least the layer 120 of weft insertions 121. During such warp changeover, as shown in FIG. 3, the binding yarn 191 crosses also the layer 140 of weft insertions. Between two consecutive warp changeovers, one weft insertion of first layer 110 or one weft insertion of second layer 120 is interlaced. As shown in FIG. 3, between two consecutive warp changeovers, one weft insertion of first layer 110 and one weft insertions of second layer 120 or one weft insertions of second layer 120 and one weft insertions of layer 140 are interlaced.

The consecutive binding yarns 191 in weft direction 104 are provided to weave according to a plain weaving structure.

In each layer 110, 120 and 140, in warp direction, 100 weft insertions per dm in warp direction are provided. In layers 130 and 150, 110 bundle drawn metal filament yarns are provided per dm in weft direction 102. The bundle drawn metal filament yarns 131 and 151 of both intermediate layers 130 and 150 are identical. In weft direction, 80 binding yarns per dm in weft direction are provided. The binding yarns 191 and the yarns 131 of layer 130 are alternating in such a way that each yarn 131 of layer 130 is adjacent to two binding yarns 191, and each binding yarn 191 is adjacent to two yarns 131 of layer 130. For each yarn 131 in layer 130, a yarn 151 of layer 151 is present, located parallel with a yarn 131.

All other features, such as yarn constructions, weaving pattern, number of weft insertions interlaced between two consecutive warp changeovers, number of warp yarns or weft insertions per meter in either warp or weft direction, are identical as the features of FIG. 2.

The woven fabric of an insert 30 has a thickness 180, for example, of 1.1 mm in a direction perpendicular to the fabric surface and a surface weight of 3300 gram per m². A fabric density of 3.6 kg/dm³ is provided.

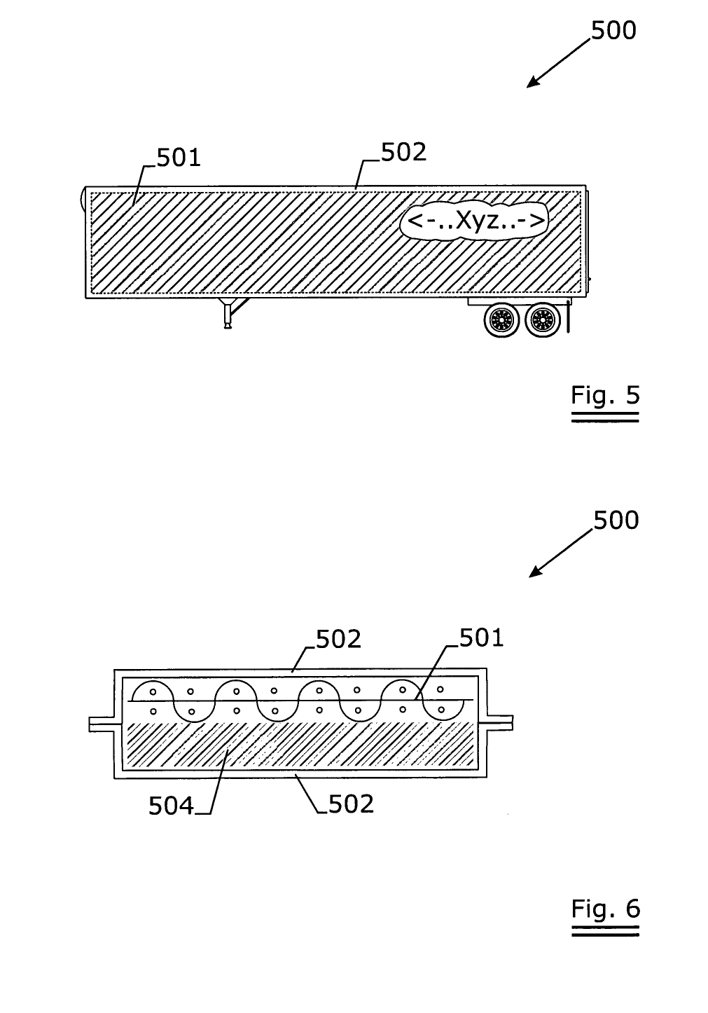

An embodiment of a protective textile product according to an embodiment of the present invention is shown in FIG. 4. The protective product, is in the case illustrated a garment, such as a vest 400, comprising a stab resistant insert 401 which may be a woven fabric 10, 20 or 30 as described above. The insert may be provided in many different parts of the vest 400, such as in the back part 404, the arm parts 402 or the breast parts 403. Possibly additional layers of textile fabrics 405, such as multi layer para aramid fabric may be provided on top or underneath the insert as subject of the present invention, in order to provide e.g. bullet protection to the garment as well.

Another embodiment of a protective textile product as subject of the present invention is shown in FIG. 5. A protective textile product comprising a stab resistant insert is a canvass 500, e.g. for lorries or trucks as shown. A cross-section of the canvass 500 is shown in FIG. 6. The canvass 500 comprises a stab resistant insert 501 which may be a woven fabric 10, 20 or 30 as described above. The insert 501 may be provided as an inlay between two layers of protective foil 502, for example polymer foil, such as e.g. PU-foil. Possibly additional layers of textile fabrics 504, such as para aramid layers may be provided on top or underneath the insert as subject of the present invention, in order to provide e.g. bullet protection to the canvass 500 as well. It is to be understood that the canvass 500 may as well be used for e.g. tent canvass or shelters.

It is to be understood that although preferred embodiments, specific constructions and configurations, as well as materials, have been discussed herein for devices according to the present invention, various changes or modifications in form and detail may be made without departing from the scope and spirit of this invention.

1-27. (canceled)

28. A stab resistant insert for protective textile product, said insert being a textile fabric comprising at least a first layer of fibers and a second layer of fibers, wherein for each of said first layer and second layer, said fibers comprise metal multifilament yarns, said textile fabric comprising a multi-layered woven fabric, said metal multifilament yarns comprising bundle drawn metal multifilament yarns.

29. A stab resistant insert as claim 28, wherein said multifilament yarns of said first and said second layer of fibers provide a first and a second layer respectively of weft insertions.

30. A stab resistant insert as in claim 29, wherein said textile fabric comprises a number of weft insertions per layer of weft insertions in the range of 80 to 150 per dm.

31. A stab resistant insert as in claim 28, wherein said textile fabric comprises a binding yarn being provided as warp yarn for forming the multi-layered woven fabric by interlacing with said at least one of said first and second layer of fibers.

32. A stab resistant insert as in claim 31, wherein said binding yarn crosses at least both the first layer of weft insertions and the second layer of weft insertions.

33. A stab resistant insert as in claim 31, wherein said binding yarn crosses at least both the first layer of weft insertions and the second layer of weft insertions during one warp changeover.

34. A stab resistant insert as in claim 31, wherein said binding yarn interlaces at least two weft insertions of said first layer of weft insertions or at least two weft insertions of said second layer of weft insertions between two consecutive warp changeovers.

35. A stab resistant insert as in claim 31, wherein the number of binding yarns per length unit in weft direction is in the range of 20 to 120 per dm.

36. A stab resistant insert as in claim 31, wherein said binding yarn comprises a bundle drawn metal multifilament yarn.

37. A stab resistant insert as in claim 28 wherein said textile fabric has a fabric density of more than 1700 g/dm³.

38. A stab resistant insert as in claim 28 wherein, wherein said textile fabric has a thickness in the range of 0.9 to 2 mm.

39. A stab resistant insert as in claim 28, wherein said textile fabric comprises a third layer of metal multifilament yarns, said multifilament yarns of said third layer providing an intermediate layer of warp yarns not interlacing with said multifilament yarns of said first and said second layer of weft insertions, said intermediate layer of warp yarns being interjacent and in contact with said first and said second layer of weft insertions.

40. A stab resistant insert as in claim 39, wherein the number of warp yarns of said intermediate layer of warp yarns per length unit in weft direction is in the range of 60 to 220 per dm.

41. A stab resistant insert as in claim 29, wherein the textile fabric comprises either or both at least one additional layer of weft insertions and at least one intermediate layer of warp yarns, which warp yarns are not interlacing with at least the weft insertions of the first and second layers of weft insertions.

42. A stab resistant insert as in claim 28, wherein the number of weft insertions per layer of weft insertions is in the range of 80 to 120 per dm.

43. A stab resistant insert as in claim 28, wherein said metal is stainless steel.

44. A stab resistant insert as in claim 28, wherein said filaments have an equivalent diameter in the range of 1 to 60 μm.

45. A stab resistant insert as in claim 28, wherein said metal multifilament yarns have a yarn fineness in the range of 100 to 2200 Tex.

46. A stab resistant insert as in claim 28, wherein said metal multifilament yarns comprise a number of filaments, the number of filaments ranging from 90 to 2200.

47. A stab resistant insert as in claim 28, wherein said metal multifilament yarns comprise singles yarns.

48. A stab resistant insert as claim 28, wherein said metal multifilament yarns comprise multiple plied yarns comprising at least two singles yarns.

49. A stab resistant insert as in claim 48, wherein each singles yarn comprises a number of filaments in the range of 90 to 1000.

50. A protective textile product comprising a stab resistant insert, said insert comprising a textile fabric comprising at least a first layer of fibers and a second layer of fibers, wherein for each of said first layer and second layer, said fibers comprise metal multifilament yarns, said textile fabric comprising a multi-layered woven fabric, said metal multifilament yarns comprising bundle drawn metal multifilament yarns.

51. A protective textile product according to claim 50, further comprising at least one additional layer of fibers.

52. A protective textile product as in claim 51, wherein the additional layer of fibers is a layer of polymer fibers.

53. A protective textile product as in claim 50, wherein said protective textile product is a garment.

54. A protective textile product as in claim 50, wherein said protective textile product is a canvas.
